(19) United States
(12) Patent Application Publication
(10) Pub. No.: US 2021/0252418 A1
(43) Pub. Date: Aug. 19, 2021

(54) SELF-SUPPORTING INFLATABLE KITE SYSTEM AND METHOD OF USE

(71) Applicant: Thomas R. Pierce, Olathe, KS (US)

(72) Inventor: Thomas R. Pierce, Olathe, KS (US)

(21) Appl. No.: 17/176,124

(22) Filed: Feb. 15, 2021

Related U.S. Application Data
(60) Provisional application No. 62/976,576, filed on Feb. 14, 2020.

(51) Int. Cl. A63H 27/08; B64B 1/40

(52) U.S. Cl. CPC A63H 27/085; B64B 1/40

(57) ABSTRACT

An inflatable kite system with an internal support structure which allows the kite to be formed into any shape desired. Shapes can include sports team logos, cartoon characters, or any other desired shape. Custom text can be printed as well for advertisement purposes. Preferably, the body is formed from Mylar, also known as BoPET (Biaxially-oriented polyethylene terephthalate), or similar materials to allow for good inflation and structural stability. The kite would be formed of two shaped pieces sealed along their edges and then sealed in multiple patterns along the faces of the two shaped pieces to form internal structural tubes. When these internal structural tubes are inflated, they act as support structures for the kite similar to existing hard-formed kite frames which rely on plastic or wooden sticks. Additional channels for being inflated may also be formed to help the kite float.

### CROSS-REFERENCE TO RELATED APPLICATION

This application claims priority in U.S. Provisional Patent Application No. 62/976,576 Filed Feb. 14, 2020, which is incorporated herein by reference.

### BACKGROUND OF THE INVENTION

### 1. Field of the Invention

The present invention relates generally to a kite and method for use thereof, and more specifically to a kite formed from inflatable material with a self-support element for deployment.

### Description of the Related Art

A kite is a tethered, heavier-than-air novelty item which has long been used by children and adults for play and entertainment. The typical kite uses a reaction against air to creative lift and drag, pulling the kite outwards away from the user along a tether, such as a string. These kites require sufficient air and space to use, therefore limiting their use to those parameters.

Heretofore there has not been available a system or method for a self-supporting inflatable kite system with the advantages and features of the present invention.

### BRIEF SUMMARY OF THE INVENTION

The present invention generally provides an inflatable kite system with an internal support structure which allows the kite to be formed into any shape desired. Shapes can include sports team logos, cartoon characters, or any other desired shape. Custom text can be printed as well for advertisement purposes. Preferably, the body is formed from Mylar, also known as BoPET (Biaxially-oriented polyethylene terephthalate), or similar materials to allow for good inflation and structural stability. The kite would be formed of two shaped pieces sealed along their edges and then sealed in multiple patterns along the faces of the two shaped pieces to form internal structural tubes. When these internal structural tubes are inflated, they act as support structures for the kite similar to existing hard-formed kite frames which rely on plastic or wooden sticks. Additional channels for being inflated may also be formed to help the kite float.

Once inflated, the kite will have a string connector mounted to a central inflated tube of the kite. The string connector could be an adhesive element, and there may be a printed indicator on the kite for placement of the adhesive element. There may also be a connector for a tail. The spaces left between the channels and structural tubes form pockets for catching wind for flying the kite.

A string reel would also be included for receiving the string. The string reel may include a string wind mechanism or hand wound reel for reeling in the string and returning the kite to the user. The reel could include character faces or other desirable shapes. A push button on the spring wind mechanism could automatically rewind the string within the wheel.

The string reels could include either strings of different thicknesses or even printed ribbon. The ribbons could be printed with designs, text, characters, or other desired images.

The present invention could be implemented to recycle and reuse old Mylar balloons. Once existing balloons have lost its helium, the balloon could be repurposed into a kite using the present concept.

### BRIEF DESCRIPTION OF THE DRAWINGS

The drawings constitute a part of this specification and include exemplary embodiments of the present invention illustrating various objects and features thereof.

FIG. 1 is a front elevational view showing various elements for the present invention.

FIG. 2 is a front elevational view thereof showing the step of creating an inflatable kite element of the present invention.

FIG. 3 is a front elevational view thereof showing the connecting of optional connector and structural support elements.

FIG. 4 is a front elevational thereof showing a connection of a string and reel handle element.

FIG. 5 is a front elevational view thereof showing additional decorative elements.

FIG. 6 is a flowchart showing the steps to practice the method of making an embodiment of the present invention.

### DETAILED DESCRIPTION OF THE PREFERRED EMBODIMENTS

I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

II. Preferred Embodiment Kite System 2

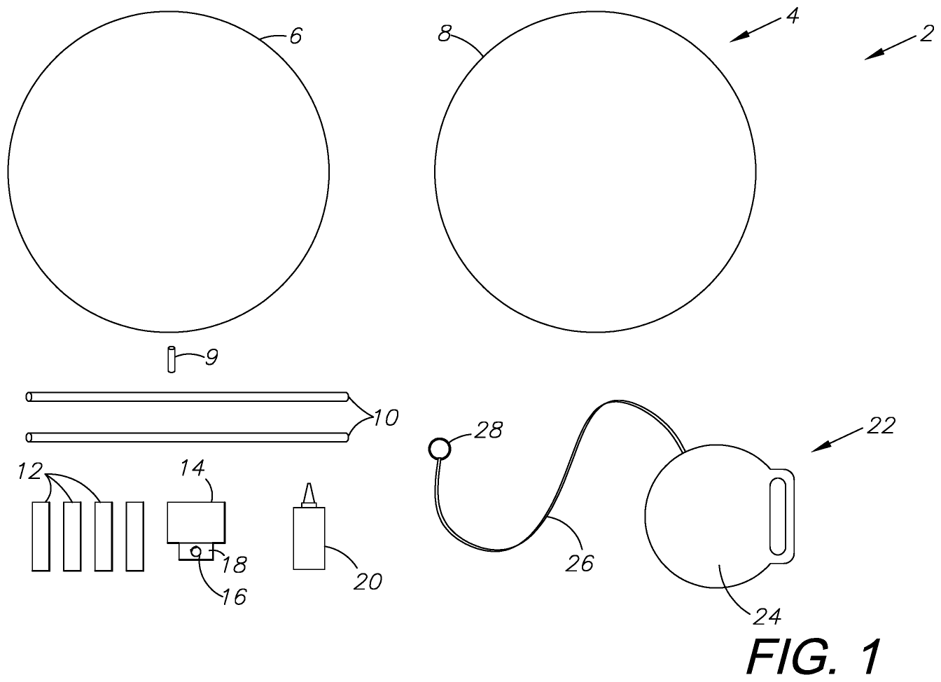

As shown in FIGS. 1-5, the present invention is a kite system 2 formed from a Mylar material, also known as BoPET (Biaxially-oriented polyethylene terephthalate), or similar materials to allow for good inflation and structural stability. This could include reusing deflated Mylar helium balloons or could include new designs from scratch.

FIG. 1 shows the main elements which are necessary for constructing a kite 4. In a preferred embodiment, the kite 4 itself is formed from two halves 6, 8, though a commercial product could be purchased by the end user as a single joined kite 4. An embodiment could be developed in which the entire kite is one unitary piece of material. The kite 4 could be of any perceivable size and shape.

Also shown in FIG. 1 is an air insert 9 for filling pockets within the kite 4 with air, helium, or other gasses. This insert 9 could instead simply be an opening within the two halves 6, 8 which form the kite which can be sealed after inflating. A number of supports 10 which can be adhered to the exterior of the kite 4 with adhesive strips 12 or through some other means. These supports 10 provide stability to the kite 4 in addition to any inflated structural channels 32.

A connector 16, such as the quick connector shown in FIG. 1 which includes the connector 16 having a receiver hole 18 and an adhesive patch 14 for securing the connector to the exterior of the kite 4. This connector 16 can receive a clip 28 of a tether device 22, such as the ribbon 26 connected to a hand reel 24. The kite 4 could, alternatively, have a connector built into the exterior of one or both of the halves 6, 8 of the kite.

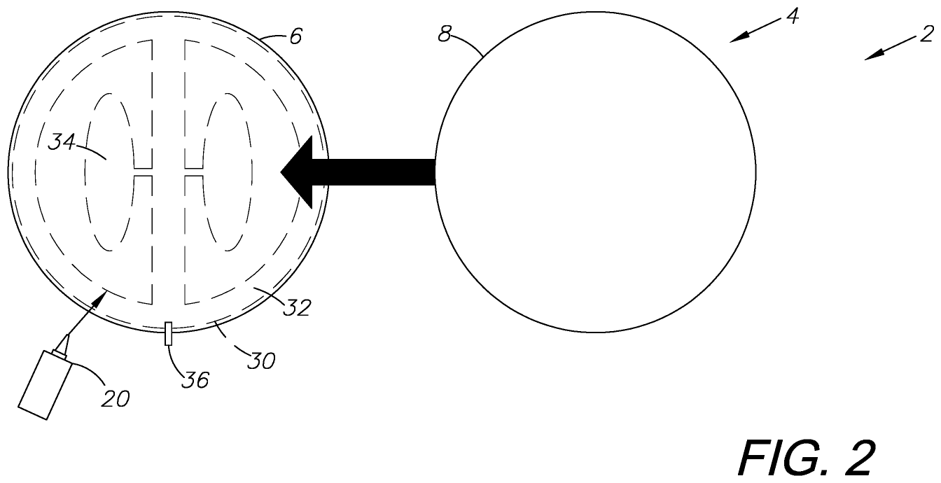

As shown in FIG. 2, in one embodiment the kite 4 is formed by creating two halves 6, 8 which are welded, melted, or glued together (e.g. with an adhesive 20), forming joining points 30 which form air chambers 34 and structural channels 32 within the interior of the two joined halves. These chambers 34 and channels 32 include structural channels which give the kite shape. The chambers 34 help to form pockets within the kite 4 designed for catching air when flying the kite. There is no limit to the size of the kite, channels, or pockets when created in this way. The two halves of the kite 4 either have a built-in inflation port, such as typical in mylar balloons. The example as shown in FIG. 2 includes an inflation port 36 which would be sealed between the two halves and which prevents air from escaping the channels 32 and pockets 34.

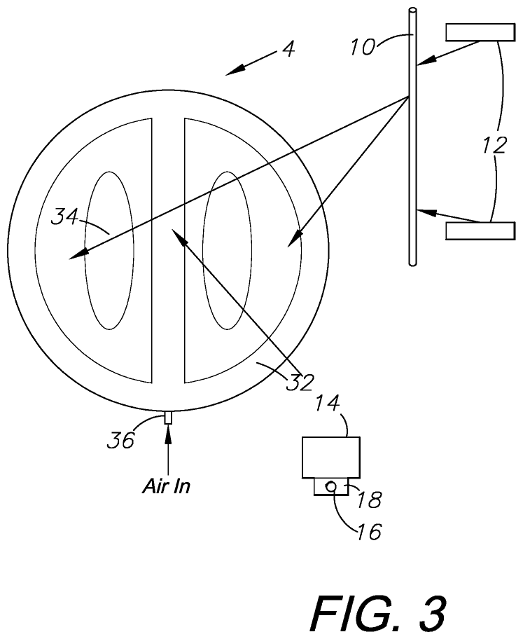

FIG. 3 shows the assembled kite 4 and the inflation thereof by inserting air, helium, or other suitable gas through the inflation port 36. The connector 16 is placed on the exterior of the kite 4 using the adhesive patch 14. Adhesive glue or other connecting means can also be used in replace of an adhesive patch. Similarly, support structures 10 are optionally connected to the exterior of one or more of the structural channels 32 to provide additional structural support to the kite 4. Adhesive strips 12 or other connection means can be used to secure the structural support 10 in place.

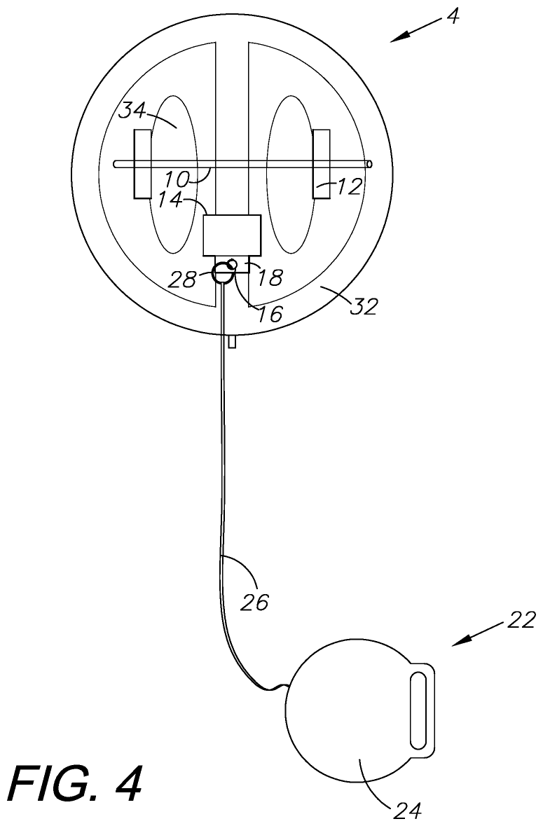

FIG. 4 shows the hand reel 24 connecting the ribbon 26 to the kite 4 via the fastening clip 28. The structural support 10 is in place along one of the structural channels 32 of the kite 4, and the kite is prepared to fly, catching air around the pockets 34 and channels 32 of the kite. The hand reel 24 as shown in the figures can be used to connect to the quick connector of the kite for either reeling in the ribbon or string using a hand crank or using a spring-wind mechanism with a switch for automatically drawing the string back into the reel.

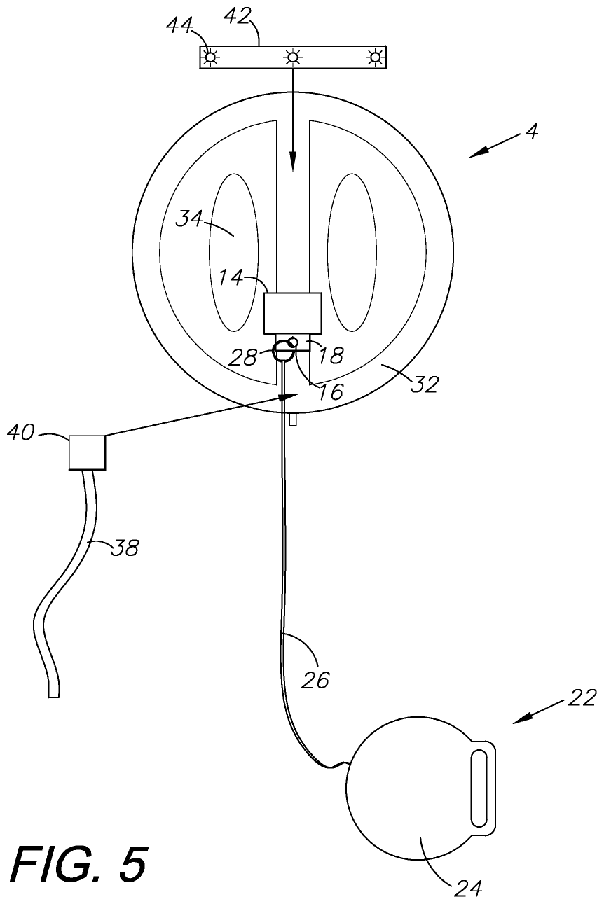

FIG. 5 shows additional decorative elements which could optionally be affixed to the exterior of the kite. These decorative elements include, but are not limited to, a tail 38 with an adhesive patch 40 and a strip 42 of light emitting diodes (LEDs) 44 which would include a battery or other power source to light up as the kite 4 is flown. The tail can be affixed to the exterior via the patch 40 similar to the patch 14 of the quick connector 16 in a similar fashion, or by using adhesive strips, adhesive glue, or other connecting means. Chemically fluorescent lighting elements or other lights can be affixed to the exterior of the kite as well.

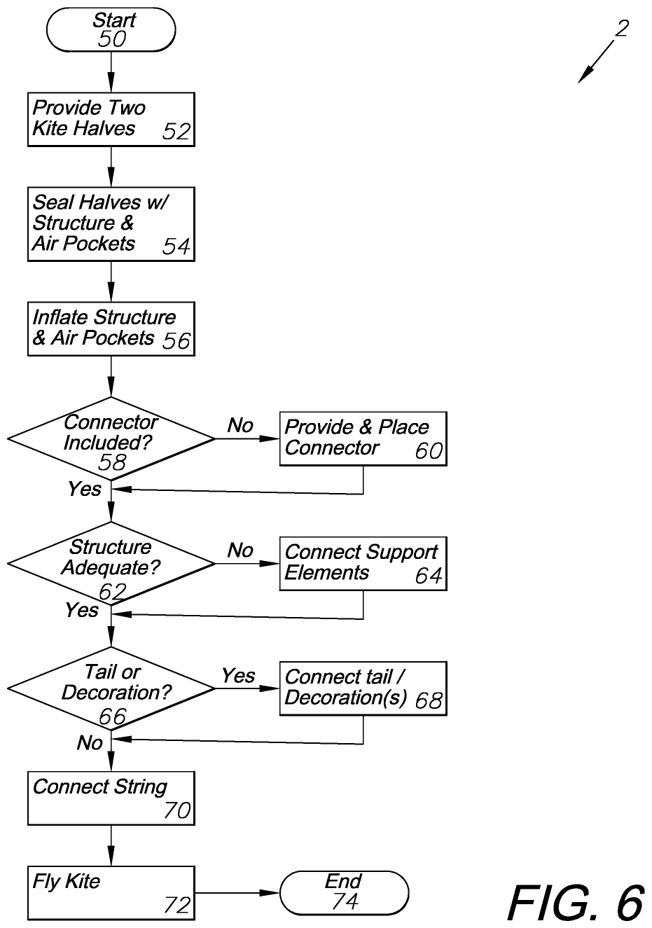

FIG. 6 shows the steps taken in practicing a method of assembling the present invention. The process starts at 50 when the two kite halves are obtained at 52. The halves are joined at 54 and the pockets and channels are inflated at 56.

If a connector is included within the kite structure at 58, move on to 62. Otherwise provide and place the quick connector element at 60.

If the structure of the channels of the kite are adequate at 62, move on to step 66. Otherwise connect the support structural elements 10 to the exterior of the kite 4 at 64.

If there are no additional tails or decorations to add, move on to step 70. Otherwise connect the tail or other decorations at 68.

The string, ribbon, or other tether device is attached to the connector at 70. The user may then fly the kite at 72 until they decide to end the process at 74.

Embodiments of the present invention could incorporate paper kites that are made from paper folded into shapes of kites and also fold it into shapes of airplanes this will allow people the opportunity to get kites made from paper that are folded but will be in kit forms that when purchased will give them instructions on how to fold the kites from paper will include colored paper will include kite string and reels. The paper can be printed in multiple colors including colors with reflective metal surfaces and allow the person folding the kites to connect with the string and the reel.

A kit could include a kite element with internal sealing locations which initially is a balloon and functions as a balloon and may even be inflated with helium. After the balloon's helium escapes, the balloon can easily be transitioned into the kite embodiment of the present invention by inflating pre-existing channels within the balloon to form a kite embodiment.

The kite body could be formed into any desired shape, either by using a pre-existing balloon of a certain shape, or by manufacturing the shape from scratch. Shapes can include sports team logos, cartoon characters, or any other desired shape. Custom text can be printed as well for advertisement purposes. Preferably, the body is formed from Mylar, also known as BoPET (Biaxially-oriented polyethylene terephthalate), or similar materials to allow for good inflation and structural stability. Print, pictures, or any other customizable text or images could be printed onto any part of the kite body.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A kite system comprising:
a kite body comprising an inflatable chamber;
an inlet within said kite body configured to receive a gaseous substance to inflate said inflatable chamber;
a connector attached to said kite body, said connector configured to receive a clip connected to a tethering device;
said inflatable chamber configured to provide structural stability to said kite body; and
said kite body configured to catch air and be flown while tethered down by said tethering device.

2. The kite system of claim 1, further comprising:
said kite body comprising two halves sealed together, thereby forming said inflatable chamber.

3. The kite system of claim 2, wherein said two halves are sealed together using a sealing element selected from the list comprising: melting; welding; and adhesive.

4. The kite system of claim 1, further comprising:
said tethering device connected to a hand reel configured to selectively reel said tethering device in; and
said tethering device further configured to selectively let said tethering device out from said hand reel.

5. The kite system of claim 1, further comprising:
an inflatable pocket, said inflatable pocket configured to be inflated from said inlet; and
said inflatable pocket configured to enhance the ability of said kite body to catch air.

6. The kite system of claim 1, further comprising:
a support structure comprising an elongated body, said support structure configured to be affixed to an external face of said kite body; and
said support structure configured to provide additional structural stability to said kite body.

7. The kite system of claim 1, further comprising:
a tail configured to be affixed to said kite body.

8. The kite system of claim 8, further comprising:
said tail comprising a tail clip configured to be affixed to a tail connector affixed to said kite body.

9. The kite system of claim 1, further comprising:
a light decoration comprising a body and a light-up element; and
said body configured to be affixed to an exterior face of said kite body.

10. The kite system of claim 1, wherein said kite body is comprised of Biaxially-oriented polyethylene terephthalate (Mylar).

11. A method of assembling a kite, the method comprising:
providing a first half and a second half of a kite body;
connecting said first half of said kite body to said second half of said kite body and forming an inflatable channel between said first half and said second half;
providing an inlet within said kite body and inflating said inflatable channel through said inlet;
connecting a clip to a connector on said kite body, said clip connected to a tethering device;
flying said kite; and
securing said kite via said tethering device.

12. The method of claim 11, further comprising the steps:
connecting said first half and said second half of said kite bodies by sealing using a sealing method selected from the list comprising: melting; welding; and gluing.

13. The method of claim 11, further comprising the steps:
providing a hand reel configured to contain said tethering device;
extending said tethering device via said hand reel; and
retracting said tethering device via said hand reel.

14. The method of claim 11, further comprising the steps:
inflating an inflatable pocket with said inlet; and
catching air with said inflatable pocket while flying said kite.

15. The method of claim 11, further comprising the step of connecting a tail to said kite body.

16. The method of claim 15, further comprising the steps:
affixing a connector to an exterior face of said kite body using an adhesive patch; and
connecting said tail to said connector via a tail clip.

17. The method of claim 11, further comprising the step of connecting a light decoration to an exterior face of said kite body, said light decoration comprising a body and a light-up element.

18. The method of claim 11, further comprising the step of affixing a support structure comprising an elongated body to an exterior face of said kite body, said support structure configured to provide structural stability to said kite body.

19. The method of claim 11, wherein said first half and said second half are comprised of Biaxially-oriented polyethylene terephthalate (Mylar).

20. The method of claim 11, wherein said first half and said second half are obtained from a pre-exisitng balloon.
